(19) United States
(12) Patent Application Publication
(10) Pub. No.: US 2010/0223466 A1
(43) Pub. Date: Sep. 2, 2010

(54) SHARED SCALABLE SERVER TO CONTROL CONFIDENTAL EVENT TRAFFIC AMONG RECORDATION TERMINALS, ANALYSIS ENGINES, AND A STORAGE FARM COUPLED VIA A PUBLIC NETWORK

(75) Inventors: Steven Goddard Roskowski, Los Gatos, CA (US); Paul H. Forrester, San Jose, CA (US)

Correspondence Address: PATENTRY, P.O. BOX 151616, SAN RAFAEL, CA, 94915-1616, US

(73) Assignee: Third Iris Corp, GRAND CAYMAN (KY)

(21) Appl. No.: 12/551,239

(22) Filed: Aug. 31, 2009

Related U.S. Application Data
(63) Continuation-in-part of application No. 12/395,437, filed on Feb. 27, 2009.

(51) Int. Cl. H04L 9/00; H04L 9/32; G06F 9/46

(52) U.S. Cl. 713/168; 726/6; 719/318

(57) ABSTRACT

A highly secure event server receiving and storing encrypted assets and references to those assets over a public wide area network. A system for selectively decrypting and transmitting references to analysis clients such as authenticated mutually unconscious users, and retrieving, decrypting and transmitting certain assets from high-volume storage, distributed storage, or in transit. A method for controlling a plurality of event recordation clients and a plurality of analysis clients transmitting policies and commands requesting upload of assets and obtaining status solely by receiving client initiated sessions.

### CROSS-REFERENCE TO RELATED PATENTS

This application is a CIP of Ser. No. 12/395,437 filed Feb. 27, 2009 U.S. Pat. No. ______ issued ______ by the present inventor which is incorporated by reference. A co-pending CIP of this application is ______ which supports related video claims.

### BACKGROUND

It is known in the art that processors as disclosed in the conclusion adapted by software programs provide means.

We define an asset to be a full record of data that elaborates an event as defined by a policy transmitted to an event recordation client from the event recordation server. Non limiting examples of assets include high resolution digital images or video streams but could be detailed data or logs. We define a reference to be a summary of an asset that is relatively compact. Non-limiting examples of references include an event type and a time stamp, a low resolution image of a face, license plate, or a photograph or a text report such as generated by character recognition, object recognition, pattern recognition, or facial recognition codes.

Thus it can be appreciated that what is needed is a server apparatus which supports immediate timely upload of references and delayed, and optional upload of assets according to demand, policies, and analysis clients operating on references.

### SUMMARY OF THE INVENTION

Within the scope of the present patent application we define an event as the collection of meta-data and assets which represent the recordation of an occurrence of interest at a point of recordation terminal (PORT). The present invention comprises a secure event server comprising:

a event recordation server circuit,
to receive references from an event recordation client, such as a point of recordation terminal,
to retrieve assets from at least one event recordation client,
to receive status from and transmit commands to each event recordation client,
to receive assets from a event recordation client incrementally according to bandwidth policy or a demand for immediate elaboration. In an embodiment an asset is retrieved and stored in encrypted format. In an embodiment an asset is retrieved and stored in digitally signed format.

The invention also includes a location server and a storage manager circuit,
to maintain location of assets for every event, and
to retrieve assets from at least one storage server.

The invention also includes an analysis server coupled to analysis clients. In an embodiment, an analysis server provides access to references, meta-data, and assets to an analysis client which may be a person or a program performing such non-limiting examples of analysis as follows: an image or character recognition function, a facial recognition function, object permanence or impermanence detection or motion detection.

This server provides seamless access to assets which may be in any one of a plurality of states. It provides using a location server, command server, and storage server:
Means for determining if a certain asset is currently stored locally and means for transmitting the asset to the requesting analysis client
Means for determining asset is stored remotely and directing request to appropriate resource for resolving a remote asset
Means for handling assets which are in process of being resolved as request is made
   wherein means comprise a processor adapted by stored commands, including converting asset request into sequence of commands to upload asset.

This server stores assets encrypted and selectively decodes assets on demand at either server or analysis client depending on analysis client capabilities.

This server supports event recordation clients which are point of recordation terminals (PORTs) which utilize only PORT initiated transactions for both assets and command interactions. This server comprises a switchboard to allow multiple servers to track status of connection, to issue commands on command channel, and to influence asset data transfer channel by sending policies.

This server automatically manages PORT configurations, including managing software configuration, dynamic status, service configuration, user preferences, and computational algorithms.

A highly secure event server receives and stores encrypted assets and references to those assets over a public wide area network. A system selectively decrypts assets to authenticated mutually unconscious users, and retrieves, decrypts and serves certain assets from high-volume storage, distributed storage, or in transit. The method controls a plurality of recordation clients and a plurality of analysis engines transmitting policies and commands, requesting upload of assets, and obtaining status solely by receiving client initiated sessions.

### BRIEF DESCRIPTION OF DRAWINGS

FIG. 1 is a block diagram of a server.

### DETAILED DISCLOSURE OF EMBODIMENTS

The server is adapted to operate coupled through a network to a network attached event recordation client comprising
an encryption circuit,
a event determination policy,
an event recognition circuit,
means for digitally signing an asset documenting the time and locus of an event recognition, and
means for summarizing an asset into a compact reference.

In an embodiment the server apparatus further provides, using a location server, a command server, and a event recordation server:
means for transmitting to an event recordation client a demand for immediate transmission of an asset, and
means for transmitting to an event recordation client a policy for delayed transmission of an asset according to an allocation of bandwidth.

In an embodiment the apparatus further provides means for policy distribution to public network attached event recordation apparatus by a processor adapted by a program product and a network interface.

In an embodiment the means for policy distribution comprises a software update circuit providing code to define meta-data to be uploaded.

In an embodiment the means for policy distribution comprises a software update circuit providing code to define an event to be recorded.

In an embodiment the means for policy distribution comprises a software update circuit providing code to define an asset to be stored and transmitted.

In an embodiment the apparatus further provides means for quantifiably provable provenance through
a decryption circuit,
a record of the keys for each event recordation apparatus,
a circuit to receive a digitally signed asset for an event,
a circuit to store a digitally signed asset.

The invention comprises a method for operating a public network attached event recordation asset server comprising:
receiving a client initiated protocol to establish connectivity,
receiving a client initiated protocol to transmit a reference to an event,
receiving a client initiated protocol to transmit an asset,
storing a reference,
receiving an analysis client request for an asset,
locating an asset,
redirecting a asset currently in transit,
reading an asset from storage,
transmitting a demand to client, and
storing an asset, without decrypting the asset.

The present invention comprises a method for operating an event recordation system provisioning a quantifiably provable provenance process comprising the steps of:
on an event recordation client apparatus:
   determining an event,
   digitally signing an asset for the event,
wherein digitally signing mathematically combines the identification of the event recordation client apparatus, the time and date, and the content of the asset in a way that any modification is quantifiably detectable,
   transmitting a reference to the asset, and
   transmitting a digitally signed asset to a server;
on an event recordation server apparatus:
   storing a digitally signed asset,
   reading a key for a certain event recordation client apparatus, and
   determining a time date and identity of the event recordation client apparatus which determined the event and signed the asset.

In an embodiment the method further comprises

on an event recordation client apparatus:
digitally signing the asset for the event,
   wherein digitally signing mathematically combines the identification of the event recordation client apparatus, the time and date, and the content of the asset in a way that any modification is quantifiably detectable,
transmitting a reference to the asset, and
elaborating the reference by transmitting a digitally signed and encrypted asset to a server;
   on an event recordation server apparatus:
storing a digitally signed and encrypted asset,
validating a certain event recordation client apparatus, and
determining a time date and identity of the event recordation client apparatus which determined the event and signed the encrypted asset.

The present invention comprises a method for operating a event server apparatus, the apparatus comprising a command server, a network interface, a storage manager, an event recordation server; the method comprising the steps:
receiving and maintaining a client session from a event recordation client apparatus,
receiving and storing a reference and
in processing an analysis server request for an asset, responding to a client request with a command to priority upload an asset.

The present invention comprises a method for operating an event server apparatus, the apparatus comprising a command server, a network interface, a storage manager, an event recordation server; the method comprising the steps:
receiving and maintaining a client session from a event recordation client apparatus,
receiving and storing a reference and receiving a bandwidth shaped upload of an asset related to the reference.

In an embodiment the method further comprises the step of

in processing an analysis server request for an asset, responding to a client request with a command to priority upload an asset related to the reference whereby an asset already in transit by bandwidth shaped upload is completed by priority upload.

In an embodiment the asset is digitally signed within the event recordation client apparatus for quantifiably provable provenance the method further comprises the steps:
receiving and storing a digitally signed asset,
validating a certain event recordation client apparatus, and
determining a time date and identity of the event recordation client apparatus which determined the event and signed the asset.

In an embodiment whereby the asset is received and stored in encrypted format within the event recordation client apparatus for privacy and not decrypted until accessed by authenticated analysis client the method further comprises the steps:
receiving and storing an encrypted asset,
authenticating an authorized analysis client, and
decrypting the asset only at the request of an authenticated authorized analysis client whereby the asset is protected in storage and during transmission by an encryption at the event recordation client apparatus and not merely by a transport layer protocol.

In an embodiment the asset is both encrypted for privacy and digitally signed for provenance by the method further comprising the steps:
receiving and storing a digitally signed and encrypted asset,
reading a key for a certain event recordation client apparatus, and
determining a time date and identity of the event recordation client apparatus which determined the event and signed the encrypted asset.

In an embodiment an event further comprises a server recognized event which is initiated by a process within the server further comprising the steps:
receiving an asynchronous interrupt from a server, analysis client, or other source to initiate a demand for event creation, asset transfer, and reference for a certain camera,
receiving and maintaining a client session from an event recordation client apparatus,
responding to a client request with a command to create an event, and at least one reference and asset and priority upload the asset to the server.

In an embodiment the invention comprises a network attached event recordation server comprising:
a decryption circuit,
means for receiving and storing a reference,
means for receiving and storing an asset,
means for decoding the time and locus of an event recognition wherein locus is the unique serial number of an event recordation client having a certain key
wherein means comprise a processor adapted by computer readable instructions.

In an embodiment the invention comprises a public network attached event recordation asset server apparatus comprising
an event recordation server,
analysis server,
storage manager circuit,
a storage server,
a network interface coupled to at least one event recordation client apparatus
wherein said event recordation server responds to a client initiated session to provide status, transmit references and assets, and obtain commands and

wherein said storage manager circuit maintains location information for every asset among three classes: in transit between the recordation client and the server, stored at the storage server, or stored at the event recordation client.

The invention comprises a method for operating an event recordation system over a public network comprising a quantifiably provable provenance process comprising the steps of:

on an event recordation client apparatus:
determining an event,
encrypting an asset for the event,
transmitting a reference to the asset, and
elaborating the reference by transmitting an encrypted asset to a server; on an event recordation server apparatus:
storing an encrypted asset without decrypting the asset,
reading a key for a certain event recordation client apparatus, and
determining a time date and identity of the event recordation apparatus for a certain asset.

The invention comprises an event server apparatus comprising:

a event recordation server circuit
to receive a reference from a event recordation client,
to receive status from and transmit commands to each event recordation client,
to receive assets from a event recordation client according to an bandwidth shaping policy for incremental fulfillment or according to a demand for elaboration,
   a command server, to retrieve assets from an event recordation client, a location server,
   a storage manager circuit,
to maintain storage location of assets, and
to retrieve assets from storage server, and
   an analysis server to determine which references are of interest.

In an embodiment the apparatus further provides means such as a processor coupled to a network interface, for transmitting an update to a event recordation client apparatus comprising configuration for determining an event, performing analysis, uploading meta-data, and transmitting a reference.

In an embodiment the apparatus further provides means such as a command server and a network interface for forcing an immediate event determination to a selected event recordation client apparatus.

In an embodiment the apparatus further comprise an authentication and decryption circuit,

and means for receiving and storing an asset in a digitally signed format;
which prevents modification of the time of day, the asset, or the identification of the event recordation apparatus without detection,
whereby provenance of the asset is quantifiably measurable and proven.

In an embodiment the apparatus further comprise

an authentication and decryption circuit, and
means such as a circuit for receiving and storing an asset in an encrypted format without decrypting it;
whereby an asset may be transmitted through a public network and stored in a shared use server without revealing the contents to unauthenticated or unauthorized parties sharing the network or server apparatus.

In an embodiment the command server comprises a circuit to
receive a request for an asset,
determine location of a asset stored on a certain event recordation client,
determine a command sequence to retrieve and deliver the asset, and
respond to an open session established by the event recordation client with a command sequence to immediately upload the asset with priority over any other event recordation client traffic.

In an embodiment, the invention comprises a method for operating a system, the system comprising,
a plurality of analysis client apparatus coupled to an analysis server apparatus by a network,
the analysis server apparatus coupled to a storage server apparatus, and
the storage server apparatus,
   the method comprising the following processes:
providing access to assets which may be in any one of a plurality of states,
determining a location for an asset currently stored,
directing a request to retrieve an asset from a storage location, and
fetching assets and storing them in high volume reliable storage.

In an embodiment the method for operating a public network attached event recordation asset server further comprises distributing a policy to a public network attached event recordation apparatus wherein a policy is a computer executable instruction to adapt a processor to transform data tangibly encoded on computer readable media.

In an embodiment the policy determines an event based on object recognition rules.

In an embodiment the policy determines an event based on facial recognition rules.

In an embodiment the policy determines an event based on object placement or movement.

In an embodiment the policy determines an event based on duration of occupancy within a part of an image field.

In an embodiment the policy determines an event based on a repetition of motions.

In an embodiment the policy determines an event based on motion detection and time of day & day of week.

In an embodiment the policy determines which meta data is transmitted by type of event.

In an embodiment the policy determines if a low resolution video frame is included in a reference.

In an embodiment the policy determines if a high resolution image is included in an asset.

In an embodiment the policy determines the immediacy of transmitting an asset to a server.

In an embodiment the policy determines the immediacy of transmitting a reference to a server.

In an embodiment the apparatus further comprises means such as a circuit, software, or processor adapted by a program product. for transmitting an update to a event recordation client apparatus configuration for determining an event, performing analysis, uploading meta-data, and transmitting a reference.

In an embodiment the apparatus further comprises means for forcing an event determination to a selected event recordation client apparatus.

In an embodiment the event recordation server circuit further comprises a circuit:
to transmit bandwidth policies to each event recordation client,
to transmit an update in event recordation policy,
to transmit an update in meta data event recordation policy and
to establish connectivity and status of every event recordation client.

The present invention comprises a secure event server comprising:

a event recordation server circuit,
to receive a reference to an asset from a event recordation client,
to receive status from and transmit commands to each event recordation client,
to receive an encrypted asset from an event recordation client according to bandwidth policy;
   an analysis server circuit,
   and a distributed storage manager circuit,
to maintain location of an asset for every event, and
to retrieve an asset from event recordation client,
to retrieve an asset from storage server.

In an embodiment the analysis server comprises a circuit:
to decrypt assets for authenticated analysis clients,
to show a timeline of event occurrences,
to provide selection of events.

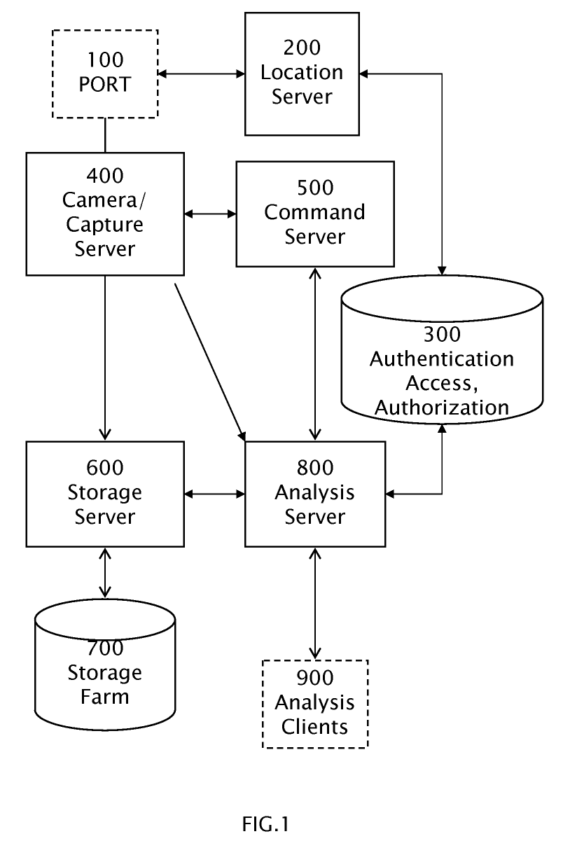

Referring now to FIG. 1, a location server 200 is coupled to a plurality of PORTs 100 and to an authentication, access, and authorization database 300. An analysis server 800 also couples to the authentication access and authorization database 300 to validate access from a plurality of analysis clients 900. The analysis server 800 further couples to a camera server 400, a command server 500, and a storage server 600. Each camera server 400 is further coupled to a plurality of PORTs 100, the command server 500, and the storage server 600. A storage farm 700 is coupled to the storage server 600.

Each location server 200 presents a fixed IP address which allows PORTs to establish a client session without needing domain name system (DNS) service.

Each camera server 400 connects a plurality of PORTs with asset and command connections. The camera server comprises
switchboard 410 to provide rendezvous point for other servers to get status and issue commands to PORTS on the command channel,
asset storer 420 to receive references and assets from PORTS over one or more connections per port. It publishes existence of assets and references as they are being uploaded, which allows other servers to handle them in real time. In a preferred embodiment, assets are transferred and stored in small chunks from camera over hypertext transfer protocol (HTTP) protocol POST method, allowing live streaming of HTTP uploaded assets.

Each storage server 600 comprises a
storer circuit 610 to fetch assets and references from camera server 400 and stores them in high volume reliable storage 700.

The command server 500 converts required action from other servers and configurations into sequences of command transactions sent to PORTs, handles error cases, and interacts with the location server 200 to determine which camera server to use for each PORT. The command server comprises a
command state machine 510 to fetch command sequences from stored command server and execute stated transactions by issuing commands to camera switchboard 410 and receiving status change updates back.
configuration management circuit 520 to automatically detect current camera configuration and issues commands to command state machine to drive PORT into target configuration.

In an embodiment the analysis server 800 provides a mechanism for user access to references, assets, and PORT configuration. The analysis server comprises
a asset server 820 to direct a request for an asset from analysis apparatus 900 to storage server 600, and handle redirection to camera server 400 and/or command server 500 in the event a certain asset is not available on storage farm 700, and
an encryption manager 830 to associate encryption keys for each specific PORT.

In an embodiment, the apparatus comprises at least one event recordation server coupled to both the command server and to the storage server, an event recordation server comprising:
a switchboard circuit, and
an asset storer circuit,
wherein the asset store or circuit receives assets and references over an http protocol POST method initiated by a PORT and transfer encoded as chunks as determined by the PORT and
wherein the switchboard circuit couples all PORTs and all servers enabling the transfer of commands and status between any PORT and any server.

In an embodiment, the apparatus further comprises
a location server coupled to a network interface
   wherein a location server comprises a fixed Internet protocol address whereby any PORT can establish a connection to a camera server without depending on the domain name system, and
   wherein location information is provided to servers which need to find a certain PORT
the location server comprising:
   a client interface which receives connections from PORTS, interface being available at a fixed IP address to avoid client DNS.
   a load balancing service which allocates PORTS to a pool of camera servers
   authentication service which validates the PORT identification information against know PORTS and provide credentials to allow access to camera servers
   a location data base which record the specific camera server a specific port is allocated to
   a location query server which provides the location data to other servers on request;
wherein a service may be implemented by a processor adapted by a program product.

The method of operating a location server comprises
receiving a request from a PORT, which includes identification information of the PORT
authenticating the PORT, wherein authenticating comprises
   one or more of the steps:
responding to the PORT request with a challenge response and receiving a subsequent request from the PORT with the appropriate response, and
validating the PORT identification information against known good PORTs
   responding to the PORT request with a nonce to use for authenticated access and an IP address to user for camera server transactions.

The method of operating a location server further comprises:
receiving a request from a valid server for the active server to use to rendezvous with a specific PORT
responding to the request with identification information for the specific camera server the PORT is associated with, and
responding with an error response if the PORT is not valid.

In a preferred embodiment, the method comprises
receiving an hypertext transfer protocol POST method request initiated by at least one point of recordation terminal,
receiving a status report from a PORT and transferring it to any server,
receiving a command from any server and transferring it to a PORT,
receiving references and assets from a PORT, and
publishing the existence of assets and references as they are being uploaded.

In an embodiment, the apparatus further comprises
a configuration management circuit coupled to the command state machine, comprising means for
   i. controlling the time and calendar of a PORT,
   ii. controlling the software configuration of a PORT,
   iii. controlling the service configuration of a PORT,
   iv. comprising a bandwidth shaping policy as a function of the camera's current storage level.

In an embodiment, the method further comprises
translating user selections in a display apparatus into configuration values and commands,
converting action requests from other servers into a sequence of command transactions,
tracking the status of issued commands, and
receiving an analysis request and initiating an asset upload.

In an embodiment, the method further comprises
automatically detecting a current PORT configuration,
issuing commands to drive a PORT into a target configuration,
setting time and date,
deploying software updates, and
specifying each PORT's bandwidth shaping to control enterprise wide bandwidth management.

### CONCLUSION

The present patent application discloses a highly secure shared event server receiving and storing encrypted assets and references to those assets over a public wide area network. This system selectively decrypts and transmits references and assets to authenticated mutually unconscious users, and retrieves, decrypts and transmits certain assets from high-volume storage, distributed storage, or in transit. The method provides for controlling a plurality of event recordation terminals and a plurality of analysis engines, transmitting policies and commands, requesting upload of assets, and obtaining status solely by receiving client initiated sessions.

The present invention may be easily distinguished from conventional systems by serving cameras as clients and receiving hypertext transfer protocol POST method requests. The present invention may be easily distinguished from conventional systems by using public networks between the camera and the server and encrypting each cameras video streams with a key unique to each camera and storing the encrypted videos streams and only decrypting the video streams using a public key upon demand of a user. The present invention may be easily distinguished from conventional systems by allocating bandwidth and distributing a bandwidth policy to each camera which autonomously uploads references and assets according to the bandwidth policy. The present invention may be easily distinguished from conventional systems by reallocating bandwidth among all cameras when a user requests a video stream asset from a certain camera.

The present invention may be easily distinguished from conventional systems by its isolation of the user from management over the physical location of assets. Assets are automatically moved among and retrieved from the server, the point of recordation or in-flight to the server. To enjoy the economy of using public networks and high-volume storage but still provide the best security, the invention encrypts data from the point of recordation through storage and only decrypts it exclusively for an authenticated user. A further distinguishing security advantage is passively receiving client initiated sessions from the point of recordation terminals for all management, configuration, and data transfer channels.

The present invention is easily distinguished from conventional system by allowing one or more PORTs to function effectively over lower bandwidth Internet connections and with less impact on other applications using the connection than conventional solutions, while providing effective and timely access to all events recorded by the PORT.

The present invention is easily distinguished from conventional systems by at least:
Cleanly dealing with assets that can be either on the server, in flight to the server, or on the event recordation client apparatus.
Encrypting data on the event recordation client, and keeping it encrypted during storage and possibly transmission
Supporting an “outbound only” management channel from event recordation clients.
Remotely managing event recordation apparatus code base and configuration
Securely intermediating between a plurality of unrelated users and the superset of their event recordation clients installed across public networks and private LANs
Supporting delayed or unresolved assets
Dynamically managing event recordation apparatus status and operating model.

It is distinctly pointed out that a conventional network security solution such as Secure Sockets Layer Certificates protects only during the transport and fails to accomplish the objective of the present invention. An asset transported by SSL would be stored at the server in unprotected form vulnerable to viewing by unauthorized persons. Nor does an SSL certificate establish a chain of evidence or quantifiably provable provenance from a specific camera as the origin of a video stream. Reencrypting or signing the asset at the server after transport encryption and decryption would fail to provide provenance and ensure security.

The techniques described herein can be implemented in digital electronic circuitry, or in computer hardware, firmware, software, or in combinations of them to provide means for the following:

an analysis server circuit comprising
means for performing regression analysis on event meta data
means for summarizing event meta data
means for correlating meta data among related event recordation clients,
means for performing specific analysis upon recognition of a trigger event,
means for categorizing events by meta data, and
means for alerting a user to a certain pattern of events;
   a user interface display and editor providing
means for forcing creation of an event, and
means for annotating additional meta-data to an event;
   a database search and analysis circuit providing
   means for searching and triggering on values and properties of events and meta data;
   a user interface and navigation display providing
   means for selecting and grouping a combination of events and annotating the group.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention. For example, other network topologies may be used. Accordingly, other embodiments are within the scope of the following claims.

What is claimed is:

1. A method for operating an event recordation system provisioning a quantifiably provable provenance process comprising the steps of:
on an event recordation server apparatus:
receiving a digitally signed asset,
authenticating an analysis client,
validating an asset upon request by an authorized authenticated analysis client,
and delivering the validated asset to the authorized authenticated analysis client;
wherein digitally signing mathematically combines the identification of the event recordation client apparatus, the time and date, and the content of the asset in a way that any modification is quantifiably detectable.

2. A method for operating an event recordation system with secure transmission and storage of assets comprising
on an event recordation server apparatus:
receiving and storing an encrypted asset,
authenticating an authorized analysis client,
decrypting the asset only at the request of an authenticated authorized analysis client, and
delivering the decrypted asset to the authenticated authorized analysis client;
whereby the asset is protected in storage and during transmission by an encryption at the event recordation client apparatus and not merely by a transport layer protocol.

3. The method of claim 2 further comprising
on an event recordation server apparatus:
receiving a digitally signed and encrypted asset,
authenticating an authorized analysis client,
retrieving the asset from storage or the event recordation client,
validating the encrypted asset only upon request of an authorized analysis client,
and delivering the asset to the authorized analysis client;
wherein digitally signing mathematically combines the identification of the event recordation client apparatus, the time and date, and the content of the asset in a way that any modification is quantifiably detectable,
wherein delivering comprises at least one of: assuring that the client has appropriate credentials and capabilities to validate or decrypt the asset, validating the asset, and decrypting the asset.

4. A method for operating a event server apparatus, the apparatus comprising a command server, a network interface, a storage manager, an event recordation server; the method comprising the steps:
receiving and maintaining a client session from a event recordation client apparatus,
receiving and storing a reference,
presenting a reference to an analysis server, and
in processing an analysis server request for an asset, responding to a client request with a command to priority upload an asset.

5. A method for operating an event server apparatus, the apparatus comprising a command server, a network interface, a location server, a storage manager, an event recordation server; the method comprising the steps:
receiving and maintaining a client session from a event recordation client apparatus,
receiving and storing a reference and receiving a bandwidth shaped upload of an asset related to the reference;
receiving a request from a PORT, which includes identification information of the PORT authenticating the PORT, comprising one or more of the steps:
responding to the PORT request with a challenge response and receiving a subsequent request from the PORT with the appropriate response,
and validating the PORT identification information against known good PORTs;
responding to the PORT request with a nonce to use for authenticated access and an IP address to use for camera server transactions;
receiving a request from a valid server for the active server to use to rendezvous with a specific PORT,
responding to the request with identification information for the specific camera server the PORT is associated with, and
responding with an error response if the PORT is not valid.

6. The method of claim 5 further comprising the step of
in processing an analysis server request for an asset, responding to a client request with a command to priority upload an asset whereby an asset already in transit by bandwidth shaped upload is completed by priority upload.

7. The method of claim 6 wherein the asset is digitally signed within the event recordation client apparatus for quantifiably provable provenance further comprising the steps:
receiving and storing a digitally signed asset,
authenticating an analysis client and
validating an asset upon request by an authorized authenticated analysis client.

8. The method of claim 6 whereby the asset is received in encrypted format within the event recordation client apparatus for privacy and not decrypted unless accessed by authenticated analysis client the method further comprising the steps:
receiving an encrypted asset,
authenticating an authorized analysis client, and
decrypting the asset only at the request of an authenticated authorized analysis client whereby the asset is protected during transmission by an encryption at the event recordation client apparatus and not merely by a transport layer protocol.

9. The method of claim 8 whereby the asset is both encrypted for privacy and digitally signed for provenance further comprising the steps:
receiving and storing a digitally signed and encrypted asset,
authenticating an authorized analysis client, and
validating as asset upon request by an authorized authenticated analysis client.

10. The method of claim 9 wherein an event further comprises a server recognized event which is initiated by a process within the server further comprising the steps:
receiving an asynchronous request from a server or analysis client to initiate a demand for event creation, asset transfer, and reference for a certain camera,
receiving and maintaining a client session from an event recordation client apparatus,
responding to a client request with a command to create an event, and at least one reference and asset and priority upload the asset to the server.

11. An event recordation system with quantifiably provable provenance apparatus comprising
a network attached event recordation server comprising:
a decryption circuit,
means for receiving and storing a reference,
means for receiving and storing an asset,
means for validating an asset traceably to a certain network attached event recordation client comprising
an encryption circuit,
a event determination policy,
an event recognition circuit, the recordation client having
means for digitally signing an asset documenting the time and locus of an event recognition, and
means for summarizing an asset into a compact reference.

12. A public network attached event recordation asset server apparatus comprising
an event recordation server,
analysis server,
storage manager circuit,
a storage server,
a network interface coupled to at least one event recordation client apparatus
wherein said event recordation server responds to a client initiated session to provide status, transmit references and assets, and obtain commands and
wherein said storage manager circuit maintains location information for every asset among three classes: in transit between the recordation client and the server, stored at the storage server, or stored at the event recordation client.

13. The server apparatus of claim 12 further comprising the following:
means for transmitting to an event recordation client a demand for immediate transmission of an asset, and
means for transmitting to an event recordation client a policy for delayed transmission of a stored asset according to an allocation of bandwidth.

14. The apparatus of claim 12 further comprising means for policy distribution to public network attached event recordation apparatus.

15. The apparatus of claim 14 comprising a software update circuit providing code to define meta-data to be uploaded.

16. The apparatus of claim 14 comprising a software update circuit providing code to define an event to be recorded.

17. The apparatus of claim 14 comprising a software update circuit providing code to define an asset to be stored and transmitted.

18. The apparatus of claim 12 further comprising means for quantifiably provable provenance and a decryption circuit,
a record of the criteria for each event recordation apparatus,
a circuit to receive a digitally signed asset for an event, and
a circuit to store a digitally signed asset.

19. A method for operating a public network attached event recordation asset server comprising the processes:
receiving a client initiated protocol to establish connectivity,
receiving a client initiated protocol to transmit a reference to an event,
receiving a client initiated protocol to transmit an asset,
storing a reference,
receiving an authenticated authorized analysis client request for an asset,
resolving an asset from storage if possible,
locating an asset by identifying a certain event recordation server,
operating an event recordation server, and delivering the asset to the authorized authenticated analysis client.

20. The method of claim 19 further comprising
redirecting a asset currently in transit,
reading an asset from storage,
transmitting a command to client to priority upload an asset, and
storing an asset.

21. The method of claim 19 wherein operating an event recordation server comprises the steps:
receiving a request for an asset,
on the condition, the asset does not yet exist, opening a receptacle for the asset, responding to a request from an event recordation client with a command to priority upload the asset, and delivering blocks of the data as they are received;
on the condition, the asset is partially uploaded from an event recordation client, responding to a request from an event recordation client with a command to priority upload the remainder of the asset, and delivering blocks of the data as they are received; and
on the condition the asset is already received, delivering the asset to the analysis server.

22. The method of claim 19 wherein delivering the asset to the authorized authenticated analysis client comprises one or more of:
assuring the client has the credentials and capability for validating or decrypting the asset, validating the asset before sending to the client, and decrypting the asset before sending to the client.

23. The method of claim 19 wherein delivering the asset to the authenticated authorized client comprises checking an opened file for available data, transferring data whenever the file has data and waiting for new data to be placed into the file.

24. The method of claim 19 for operating a public network attached event recordation asset server further comprising
distributing a policy to a public network attached event recordation apparatus wherein a policy is a computer executable instruction to adapt a processor to transform data tangibly encoded on computer readable media.

25. The method of claim 24 wherein a policy determines an event based on object recognition rules.

26. The method of claim 24 wherein a policy determines an event based on facial recognition rules.

27. The method of claim 24 wherein a policy determines an event based on object placement or movement.

28. The method of claim 24 wherein a policy determines an event based on duration of occupancy within a part of an image field.

29. The method of claim 24 wherein a policy determines an event based on a repetition of motions.

30. The method of claim 24 wherein a policy determines an event based on motion detection and time of day & day of week.

31. The method of claim 24 wherein a policy determines which meta data is transmitted by type of event.

32. The method of claim 24 wherein a policy determines if a low resolution video frame is included in a reference.

33. The method of claim 24 wherein a policy determines if a high resolution image is included in an asset.

34. The method of claim 24 wherein a policy determines the immediacy of transmitting an asset to a server.

35. The method of claim 24 wherein a policy determines the immediacy of transmitting a reference to a server.

36. An event server apparatus comprising:
a event recordation server circuit
to receive a reference from a event recordation client,
to receive status from and transmit commands to each event recordation client,
to receive and store assets from a event recordation client according to an bandwidth shaping policy for incremental fulfillment or according to a demand for elaboration, a command server, to retrieve assets from an event recordation client,
a storage manager circuit,
to maintain storage location of assets for every event, and
to retrieve assets from storage server, and
an analysis server to determine which references are of interest.

37. The apparatus of claim 36 further comprising means for transmitting an update to a event recordation client apparatus comprising configuration for determining an event, performing analysis, uploading meta-data, and transmitting a reference.

38. The apparatus of claim 36 further comprising means for forcing an immediate event determination to a selected event recordation client apparatus.

39. The apparatus of claim 36
further comprising an authentication and decryption circuit,
and means for receiving and storing an asset in a digitally signed format
which prevents modification of the time of day, the asset, or the identification of the event recordation apparatus without detection,
whereby provenance of the asset is quantifiably measurable and proven.

40. The apparatus of claim 36
further comprising an authentication and decryption circuit and
means for receiving and storing an asset in an encrypted format without decrypting it whereby an asset may be transmitted through a public network and stored in a shared use server without revealing the contents to unauthenticated or unauthorized parties sharing the network or server apparatus.

41. The apparatus of claim 36, further comprising a location server comprising:
a client interface which receives connections from PORTS, interface being available at a fixed IP address to avoid client DNS,
a load balancing service which allocates PORTS to a pool of camera servers,
authentication service which validates the PORT identification information against know PORTS and provide credentials to allow access to camera servers,
a location data base which record the specific camera server a specific port is allocated to, and
a location query server which provides the location data to other servers on request;
wherein the command server comprises a circuit to
receive a request for immediate elaboration of a reference,
determine location of a asset stored on a certain event recordation client,
determine a command sequence to retrieve and deliver the asset, and
respond to an open session established by the event recordation client with a command sequence to immediately upload the asset with priority over any other event recordation client traffic.

42. A method for operating a system,
the system comprising,
a plurality of analysis client apparatus coupled to an analysis server apparatus by a network,
the analysis server apparatus coupled to a storage server apparatus, and
the storage server apparatus,
the method comprising the following processes:
providing access to assets which may be in any one of a plurality of states,
determining a location for an asset currently stored,
directing a request to retrieve an asset from a storage location, and
fetching assets and storing them in high volume reliable storage.

43. The method of claim 42 further comprising the steps following:
receiving a hyper text transfer protocol POST method request initiated by point of recordation terminal,
receiving a status report from a PORT and transferring it to any server,
receiving a command from any server and transferring it to a PORT,
receiving references and assets from a PORT, and
publishing the existence of assets and references as they are being uploaded.
